(19) United States
(12) Patent Application Publication
(10) Pub. No.: US 2020/0226962 A1
(43) Pub. Date: Jul. 16, 2020

(54) Sign Frame

(71) Applicant: Benjamin Glade Casper, Basin City, WA (US)

(72) Inventor: Benjamin Glade Casper, Basin City, WA (US)

(21) Appl. No.: 16/744,120

(22) Filed: Jan. 15, 2020

Related U.S. Application Data
(60) Provisional application No. 62/792,774, filed on Jan. 15, 2019.

(51) Int. Cl. G09F 15/00; B25D 1/16

(52) U.S. Cl. CPC G09F 15/0012; B25D 1/04; B25D 1/16

(57) ABSTRACT

A system comprising a jig comprising a first hollow tube and a second hollow tube coupled together by at least one cross member, a first stake drivable into a ground surface while the first stake is disposed within the first hollow tube, and a second stake drivable into the ground surface while the second stake is disposed within the second hollow tube.

### RELATED APPLICATION

This application claims benefit under 35 U.S.C. § 119(e) of U.S. Provisional Application Ser. No. 62/792,774, entitled “SIGN FRAME” filed Jan. 15, 2019. The disclosure of this application is herein incorporated by reference.

### BACKGROUND

Most sign frames used by, e.g., commercial real estate agents have remained the same for decades. Such signs may include two four-inch by four-inch posts partially buried vertically in the ground with a four-foot by four-foot plywood sign attached between them. Some signs are even larger with the same posts supporting a four-foot by eight-foot sign. These large posts have to be transported and buried in holes shoveled out of the ground. Transporting and installing these long and heavy posts is a formidable job.

### BRIEF DESCRIPTION OF THE DRAWINGS

Like reference numbers and designations in the various drawings indicate like elements.

FIG. 1 illustrates elements of a sign frame in accordance with certain embodiments.

FIG. 2 illustrates an assembled sign frame in accordance with certain embodiments.

FIG. 3A illustrates a sign frame jig and a slightly raised position of a stake pounder in accordance with certain embodiments.

FIG. 3B illustrates a sign frame jig and a lowered position of a stake pounder in accordance with certain embodiments.

FIG. 4A illustrates a stake pounder in contact with a stake prior to stake removal in accordance with certain embodiments.

FIG. 4B illustrates a stake pounder removing a stake in accordance with certain embodiments.

Like reference numbers and designations in the various drawings indicate like elements.

### DETAILED DESCRIPTION

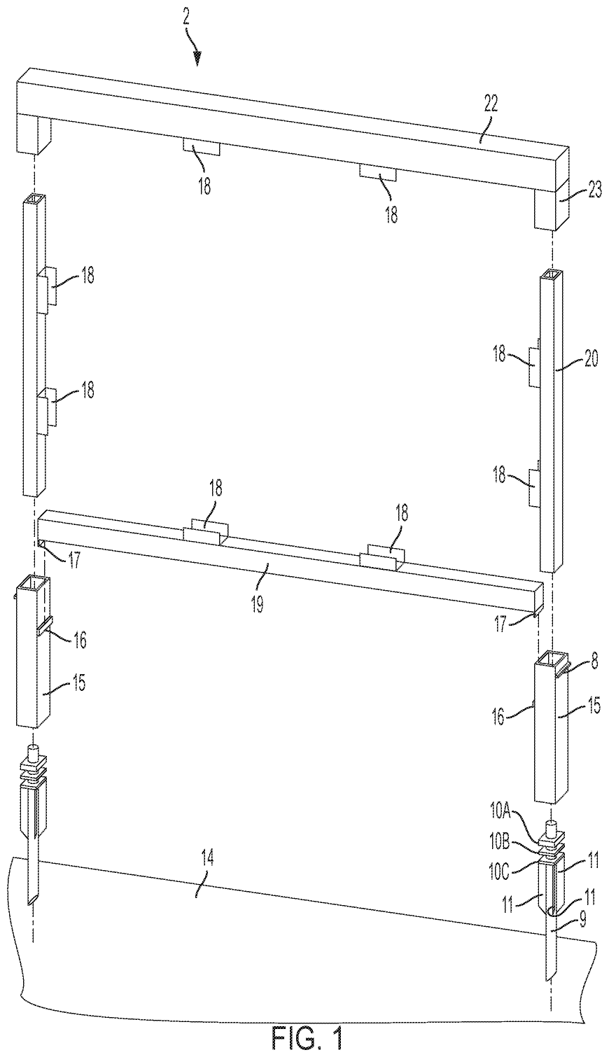

FIG. 1 illustrates elements of a sign frame 2 in accordance with certain embodiments. Various embodiments of the present disclosure provide a sign frame 2 that is much easier to transport, install, and uninstall than existing sign frames.

In the embodiment depicted, sign frame 2 comprises two stakes 9, two lower tubes 15, two upper tubes 20, a lower cross member 19, and an upper cross member 22. In one embodiment, these components slide together to form sign frame 22 without use of attachment mechanisms such as screws or nails. The stakes may be specially adapted to be driven into the ground 14, alleviating the time-consuming and physically exhausting work of shoveling, especially in hard or rocky ground. The relatively narrow stakes 9 are driven into the ground and retrieved with much less time and effort than would be required for standard wood posts. The stakes 9 alleviate the need for a shovel during sign frame installation.

A tubular frame (e.g., comprised of a rigid material such as metal, high density plastic, or other suitable material) including the remainder of the components of the sign frame 2 is quickly and easily slid over the foundation provided by the stakes 9 and fitted together to provide a strong and attractive assembly. Since the frame is distributed into multiple components, the individual pieces are relatively light and the pieces can be handled at the user's discretion, which may be far preferable to handling the large, cumbersome, and heavy four by four lengths of posts normally used to support signage.

In the embodiment depicted, each stake 9 may include a bottom edge that is adapted to facilitate insertion of the stake 9 into the ground. For example, in the embodiment depicted, the bottom edge of the stake 9 is angled from one side to the other. As another example, the bottom edge could be angled inward towards a sharp central point.

In various embodiments, the stake 9 may comprise a solid circular or rectangular rod. In other embodiments, the stake 9 may be at least partially hollow.

In the embodiment depicted, a stake 9 also includes a plurality of fins 11 extending outwards from the main portion of the stake. Other embodiments may omit fins, may have one fin, or may have a different number of fins. The fins 11 may be equally spaced (or otherwise spaced) along the outer perimeter of the stake (e.g., in the embodiment depicted, each stake includes four fins each spaced 90 degrees from each other). The fins 11 may be relatively narrow so as to facilitate easy driving of the stake 9 into the ground while providing for increased surface area contact between the ground 14 and the stake 9 to provide improved lateral stability for the stake. In the embodiment depicted, the lower edge of a fin 11 is angled outward from the edge of the main portion of the stake 9. In other embodiments, the main body of stake 9 may be attached to one or more fins having shapes differing from those shown or to other components to provide stability for the stake within the ground 14.

Stakes 9 may also include one or more stake guides 10. As an example, in the embodiment depicted, stake 9 includes upper stake guide 10A, middle stake guide 10B, and lower stake guide 10C. The stake guides 10, when used in conjunction with a jig (to be explained later) may facilitate proper placement of the stakes 9 with respect to each other and with respect to the ground 14. In the embodiment depicted, each stake guide 10 comprises a square piece placed in a horizontal orientation around the main portion of the stake 9 above the fins 11, although the guides may have any suitable orientation (e.g., horizontal, vertical, or a combination of horizontal and vertical with respect to the stake 9) or shape (e.g., circular, rectangular, fin-shaped, etc.). In some embodiments (and as shown), the upper guide 10A is thicker than the middle guide 10B and the lower guide 10C (which may have equal thicknesses or may have different thicknesses), although in other embodiments any variety of thicknesses may be utilized.

After the stakes 9 are driven into the ground, lower tubes 15 may be placed over the stakes (including guides 10). For example, the tubes may be hollow (or at least the lower end of the tube is hollow) and the hollow lower end of the lower tube 15 may be placed over a stake such that one or more of the stake guides 10 as well as the main portion of the stake 9 that is above ground is recessed within the inside of the lower tube 15. The size of the stake guides 10 may be based on the size of the lower tube 15 such that the stake guides 10 are slightly narrower than the inner diameter of the lower tube 15 to provide lateral support and stability for the lower tube 15. The bottom of the lower tube 15 may interface with the ground 14 (alternatively the bottom of the lower tube 15 may be supported above the ground by the stake 9).

The upper tubes 20 may be placed above and in contact with the lower tubes 15 in any suitable manner. For example, the upper tubes 20 may have a smaller diameter than the lower tubes 15 and a bottom portion of an upper tube 20 may be recessed within an upper portion of a lower tube 15. Alternatively, upper tubes 20 could have a smaller diameter and the bottom portion of an upper tube 20 may be placed around a top portion of a lower tube 15. In other embodiments, the upper tube 20 may be attached to the lower tube 15 in any other suitable manner. In one embodiment, the movement of the upper tube 20 downwards with respect to the lower tube 15 may be limited by a lower tube stop 8 of the lower tube 15. The lower tube stop 8 may be placed inside the lower tube 15 or may be a fixture that is partially located outside the lower tube that penetrates inside the lower tube 15 and prevents the bottom of upper tube 20 from descending past the lower tube stop 8 to achieve a desired height of upper tube 20 relative to lower tube 15. For example, the lower tube stop 8 may be a weld to the outside of the lower tube 15 that penetrates the inside of the tube, a pin placed through the lower tube 15, or a bolt or a screw placed through at least a portion of the lower tube 15, or other suitable mechanism. The bottom of the upper tube 20 may contact the lower tube stop 8 and the lower tube stop 8 may provide vertical support to the upper tube 20.

Either prior to or after the upper tube 20 is placed on the lower tube 15, the lower cross member 19 may be placed between lower tubes 15 to couple the lower tubes 15 together. In the embodiment depicted, this placement may be effected by placing the tongues 17 of the lower cross member 19 into the tongue pockets 16 of the lower tubes 15. In other embodiments, the lower cross member 19 may be attached to the lower tubes 15 using any suitable methods.

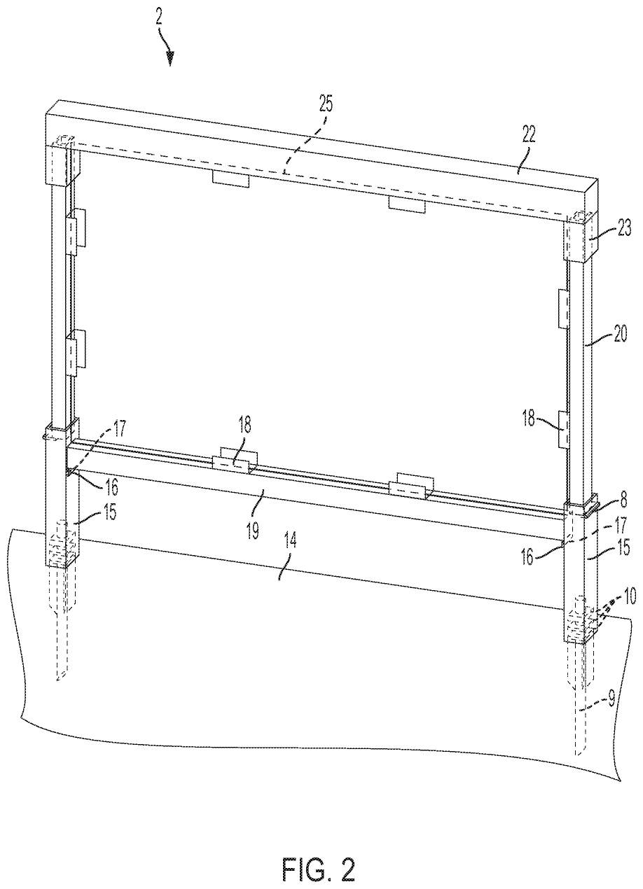

At this point a sign may be placed within the partial frame that has been formed (the placed sign is depicted in FIG. 2). Upper cross member 22 may then be placed between upper tubes 20 in any suitable manner. In the embodiment depicted, the upper cross member 22 has two top receivers 23 (one on each side) that may be placed over upper portions of the upper tubes 20. In alternative embodiments, the top receivers 23 could be inserted within the upper portions of upper tubes 20 or attached to the upper portions of upper tubes 20 in other suitable manner. In one embodiment, the upper cross member 22 may omit the top receivers 23 and may attach to the upper tubes 20 in any suitable manner (e.g., using a tongue and tongue pocket mechanism similar to that of the lower cross member 19).

In various embodiments, one or more of the components of the sign frame may include one or more sign brackets 18 which are adapted to secure a sign placed within the sign frame 2. In the embodiment depicted, each of the upper tubes 20, the lower cross member 19, and the upper cross member 22 include two sign brackets 18. In the embodiment depicted, the sign brackets 18 have a “U” shape, where the sign may be placed within the sides of the U and the sign brackets may provide lateral support for the sign. In other embodiments, any number of brackets may be included on the relevant components of the frame 2 and the brackets may have any suitable shape. In addition or as an alternative to brackets, the sign frame 2 may utilize any suitable means of attachment to secure a sign within the sign frame 2.

In a particular embodiment, the sign may be placed within the frame 2 prior to the placement of the upper cross member 22, which may be placed over the sign and the rest of the frame 2 in a final step. The sign frame 2 may be quickly and easily disassembled by pulling the components apart (or otherwise detaching the components) in a reverse order of the assembly.

FIG. 2 illustrates an assembled sign frame 2 in accordance with certain embodiments. FIG. 2 also depicts a sign 25 placed within the assembled sign frame 2.

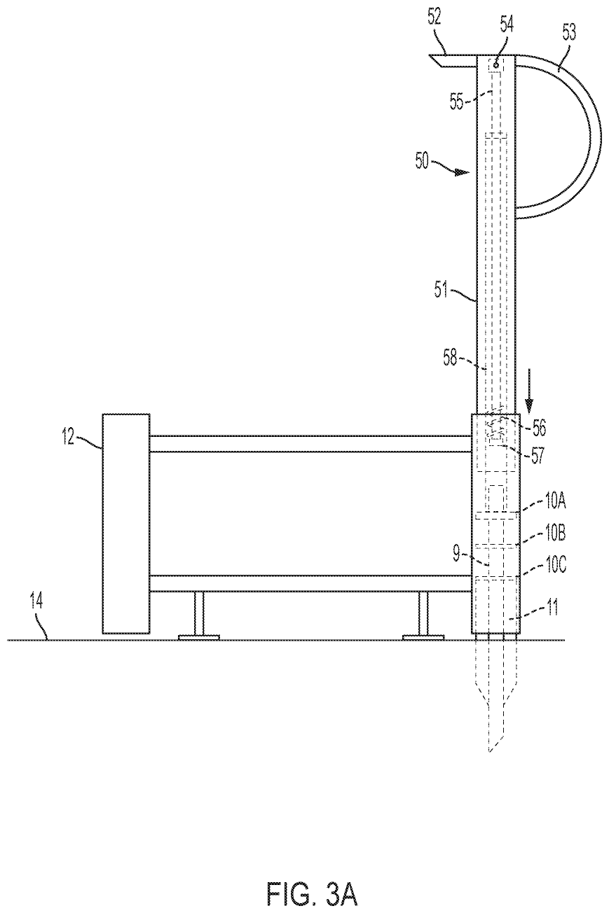

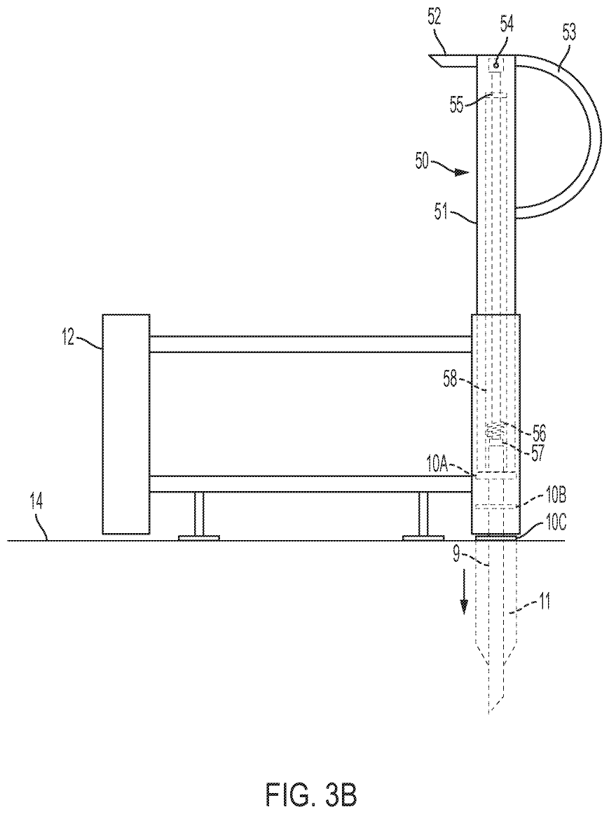

FIG. 3A illustrates a sign frame jig 12 and a slightly raised position of a stake pounder 50 in accordance with certain embodiments. Jig 12 ensures proper alignment and placement of stakes 9 with respect to each other. The jig 12 includes two hollow tubes (one on each side of the jig) through which the stakes 9 are placed when the stakes are pounded into the ground 14. In this manner, the stakes 9 will be placed at the correct distance from each other, providing the foundation for a properly aligned sign frame 2.

The hollow tubes of the jig 12 may be fixably (or removably) coupled together via one or more cross members (in the embodiment depicted two cross members are shown). In the example shown, the lower cross member of the jig 12 is also coupled to two stands (though in other embodiments, any suitable number of stands may be used) that contact the ground 14 to support the jig 12. The stands may be slightly taller than the lower portions of the hollow tubes of the jig 12 (the portions starting at the lower cross member proceeding downward) such that a gap exists between the bottoms of the hollow tubes of the jig 12 and the ground 14 to allow for visual inspection of the stakes 9 by the operator driving the stakes into the ground, such that the operator may determine when the stakes 9 have reached an acceptable depth. In alternative embodiments, the hollow tubes may extend all the way to the ground.

The stakes 9 may be driven into the ground 14 using a stake pounder 50. In the embodiment depicted, stake pounder 50 includes a pounder tube 51 coupled to a handle 53 (which may double as a fulcrum when stakes 9 are being removed as will be explained below). Stake pounder 50 also includes a pry lip 52, a rod 55 coupled to the top of the pounder tube 51 via a rod bolt 54 (or other suitable attachment mechanism), a slider 58 which is placed within the pounder tube 51 and over the outside of the rod 55, a rod spring 56 placed around the rod 55, and a rod base 57 at the bottom end of the rod 55 upon which the rod spring 56 may rest in the absence of upward force being applied to rod spring 56. The slider 58 allows pounder 50 to maintain alignment with the stake 9 while the stake is driven into the ground and allows for a much greater range of upward motion of the stake pounder 50 while still maintaining alignment between the pounder 50 and the hollow tube of the jig 12 (without the slider the pounder tube 51 would lose alignment with the hollow tube of the jig 12 once the bottom edge of the pounder tube 51 was raised above the top edge of the hollow tube of the jig 12).

In an embodiment, the main component of the slider is a hollow tube. The top of the slider 58 may include a cap with an aperture through which rod 55 may be placed (where the diameter of this aperture is smaller than the diameter of the tube at the bottom of the tube). This aperture allows the slider 58 to move up and down relative to the rod 55 (or vice versa). The rod base 57 may be wider than the main portion of the rod 55 such that rod spring 56 cannot escape past the bottom of the rod 55 and the bottom of the rod 55 cannot escape through the top (e.g., cap) of the slider 58.

When a stake 9 is to be driven into the ground, the jig 12 is placed at a desired location and a stake 9 is placed through the cavity of one of the hollow tubes. The size of the stake guides 10 may be based on the size of the hollow tube such that the stake guides 10 are slightly narrower than the inner diameter of the hollow tube to support the stake in a vertical orientation (e.g., by restricting horizontal movement of the stake 9) within the hollow tube without unduly restricting vertical movement of the stake 9. Thus, the stake 9 may be dropped into the hollow tube and the bottom edge of the stake 9 may be allowed to contact ground 14.

FIG. 3A depicts a slightly raised position of the stake pounder 50. The bottom portion of slider 58 is placed over and around the outside perimeter of the top portion of stake 9 and may rest on the top of stake guide 10A. Stake pounder 50 is raised by the operator, which also raises rod bolt 54 and rod 55. When the pounder 50 is raised to a particular position, rod base 57 pushes rod spring 56 up against the top of the slider 58 which results in compression of the rod spring 56, cushioning the impact that would otherwise occur between the top of the slider 58 and the rod base 57. The raising motion also raises slider 58 in preparation for a downward movement of the stake pounder 50 by the operator.

After being raised, the pounder 50 is forcefully lowered and the bottom edge of pounder tube 51 strikes the top of upper stake guide 10A, driving the stake 9 into the ground 14. FIG. 3B depicts the lowered position of the stake pounder 50 with the bottom edge of pounder tube 51 in contact with the upper stake guide 10A. As described earlier, in some embodiments, the upper stake guide 10A is thicker than one or more other stake guides in order to better absorb the force transferred from the stake pounder 50 to the stake 9.

The operator may raise and lower the stake pounder 50 any number of times until the stake is sufficiently seated in the ground 14. In one embodiment, the lower stake guide 10C may support the stake within the hollow tube of the jig 12 as well as provide a visual marker to the operator indicating the level of the stake 9 with respect to the ground (e.g., the operator may stop pounding the stake 9 when the lower stake guide 10C contacts the ground 14). This process may be repeated for the other stake within the other hollow tube of the jig 12 (or multiple other stakes within other hollow tubes of jig 12 if more than two stakes are used).

After the stakes 9 are driven into the ground 14, the jig 12 is removed by lifting the jig upwards. The resulting positions of the stakes 9 are separated by a distance compatible with the lengths of the lower cross member 19 and upper cross member 22 such that when the lower tubes 15 and upper tubes 20 are attached to the stakes 9, the cross members may be easily attached to the respective tubes.

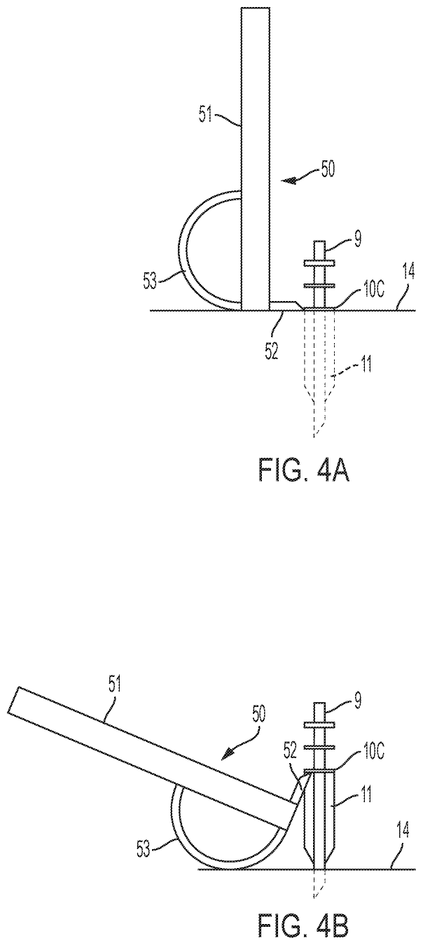

FIG. 4A illustrates the stake pounder 50 in contact with a stake 9 prior to stake removal in accordance with certain embodiments. A sign frame 2 may be disassembled by removing the upper cross member 22, the sign 25, the upper tubes 20, lower cross member 19, and lower tubes 15 (in that order or other suitable order).

Stakes 9 can then be easily pulled from the ground 14 by inserting pry lip 52 underneath lower stake guide 10C as depicted in FIG. 4A. Pry lip 52 may have suitable shape, such as a wedge or lever, or other suitable shape. Thus, the stake pounder 50 may be placed in an upside down orientation relative to its orientation when pounding a stake 9. The operator may pull back on the bottom portion of pounder tube 51 (which in reverse orientation is the highest point of the stake pounder 50). This may rotate the stake pounder 50 about the handle 53, which is now functioning as a fulcrum. This operation is depicted in FIG. 4B. The rotation of the stake pounder 50 raises the pry lip 52, exerting upward pressure on lower stake guide 10C, thus pulling the stake 9 from the ground. Once stake 9 is raised a few inches, it may be easily pulled out of ground 14 by hand if desired.

Although the FIGs. depict certain shapes and numbers of components, the shapes and/or number of components may be modified in various embodiments. For example, the frame may include more than two stakes. As another example, a lower tube 15 and upper tube 20 may be combined into a single tube. As yet another example, a stake 9 may be attached to a lower tube 15.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A system comprising:
a jig comprising a first hollow tube and a second hollow tube coupled together by at least one cross member;
a first stake drivable into a ground surface while the first stake is disposed within the first hollow tube; and
a second stake drivable into the ground surface while the second stake is disposed within the second hollow tube.

2. The system of claim 1, wherein the first stake comprises a main portion comprising a rod and at least one stake guide extending outward from an outer perimeter of the rod, the stake guide to align the first stake within the first hollow tube of the jig.

3. The system of claim 1, further comprising:
a first tube slidable on top of the first stake such that the first tube rests over the first stake in a vertical orientation; and
a second tube slidable on top of the second stake such that the second tube rests over the second stake in a vertical orientation.

4. The system of claim 3, wherein the first stake comprises at least one stake guide to align the first stake within the first hollow tube of the jig when the stake is being driven into the ground surface and to provide support to the first tube when the first tube is placed on top of the first stake.

5. The system of claim 3, further comprising a first cross member adapted to be coupled between the first tube and the second tube, the cross member comprising at least one bracket to support a lower portion of a sign.

6. The system of claim 5, further comprising:
a third tube slidably couplable to the top of the first tube;
a fourth tube slidably couplable to the top of the second tube; and
a second cross member couplable between the third tube and the fourth tube, the second cross member comprising at least one bracket to support an upper portion of the sign.

7. The system of claim 1, the jig further comprising at least one stand coupled to a cross member of the jig, the at least one stand to rest upon the ground surface and support the jig.

8. The system of claim 7, wherein the at least one stand have a height that maintains a gap between a bottom of the first hollow tube and the ground surface and a second gap between a bottom of the second hollow tube and the ground surface.

9. The system of claim 1, wherein the jig comprises:
a first cross member coupled between the first hollow tube and the second hollow tube; and
a second cross member coupled between the first hollow tube and the second hollow tube.

10. The system of claim 1, further comprising a stake pounder comprising a slider tube within a second tube, wherein the second tube is adapted to contact the first stake to drive the first stake into the ground surface.

11. The system of claim 10, wherein at least a portion of the slider tube and the second tube are placed within the first hollow tube to drive the first stake into the ground surface.

12. The system of claim 11, wherein the second tube is adapted to contact a stake guide of the first stake to drive the stake into the ground surface.

13. The system of claim 11, wherein the slider tube is adapted to maintain contact with the first stake when the second tube is raised past a top of the first hollow tube of the jig.

14. The system of claim 10, the stake pounder further comprising a rod placed at least partly within the slider tube.

15. The system of claim 14, the stake pounder further comprising a spring placed over the rod, the spring to dampen contact between a bottom portion of the rod and a top portion of the slider tube.
